(19) United States
(12) Patent Application Publication
(10) Pub. No.: US 2015/0287412 A1
(43) Pub. Date: Oct. 8, 2015

(54) 3C Smart Ring

(71) Applicant: WHYNOT TECH CO., LTD., Taipei City (TW)

(72) Inventor: Zhi Hong Tang, Taipei City (TW)

(73) Assignee: WHYNOT TECH CO., LTD., Taipei City (TW)

(21) Appl. No.: 14/670,211

(22) Filed: Mar. 26, 2015

(30) Foreign Application Priority Data
Apr. 2, 2014 (TW) 103112315

(51) Int. Cl. G10L 17/22; H04R 1/02; A44C 9/00; H04R 1/08

(52) U.S. Cl. CPC G10L 17/22; H04R 1/08; H04R 1/02; A44C 9/0053

(57) ABSTRACT

A 3C smart ring, capable of coupling 3C products in a cable or wireless communication manner, mainly includes a ring body, a power supply unit, a power switch, a control unit, a transmitting/receiving unit and a microphone. The power supply unit and the transmitting/receiving unit are both coupled electrically with the control unit. The power supply unit is to provide electricity for operating the 3C smart ring. Through the transmitting/receiving unit, the 3C smart ring can couple via wireless signals to 3C networking devices. Further, the power switch and the microphone are located at a lateral side of the ring body, in which the power switch for controlling on/off of the whole ring is coupled electrically with the control unit. The microphone coupled electrically with the control unit is to forward voice signals to the networking 3C devices via the control unit and the transmitting/receiving unit.

This application claims the benefit of Taiwan Patent Application Serial No. 103112315, filed Apr. 2, 2014, the subject matter of which is incorporated herein by reference.

### BACKGROUND OF INVENTION

1. Field of the Invention

The invention relates to a 3C smart ring, and more particularly to the 3C smart ring that can be one-handed operated and can communicate via cable or wirelessly with a 3C product such as a smart phone, a tablet, a computer or any built-in operation system the like so as further to forward the user's speech to a speech recognition system of the 3C product for being directly translated into corresponding word sequences, displayed through application software, or integrated with the voice control function of the 3C product to achieve rapid audio input.

2. Description of the Prior Art

With progress in communication technology and the rapid growth and development in the related business segment, multi-function portable electronic products have become the mainstream products currently in the marketplace. Further, due to the rise both in popularity of the wireless networking and in the data transmission rate, the life, communicative and social style of modern people has been greatly changed. Obviously, the traditional letter or telephone communicative style has been upgraded to the style of e-mail exchange, and further to the instant messaging between personal websites, such as Facebook, Twitter, LINE, Whatsapp, Wechat and so on. Growth in such kind of communicative software has completely altered the social relationships and activities of ordinary people.

It has been suggested that a high percentage of civilians cannot live without the communicative software, and also a big portion of daily life have been spent on these 3C products. In particular, no matter where people are, at home, in school, at work, in a bus or at a restaurant, a familiar picture is that people dig themselves into their mobile phones by having fingers sliding over the tiny touch screens over and over again. Without a specific agenda, they just wanted to constantly monitor their friend circles exchanges or any new message posted over the network.

Since communication is interactive, so the usage of the 3C smart products involves both input/receiving and output/transmitting. No matter what the 3C smart product is, a mobile phone or a tablet computer, the message generation is still dependent on the operation of the screen keyboard. In the keyboard operation, the user generates the literal message via typing in accordance with a specific input method. Generally, finger typing according to the input method is a comparatively slow input choice. Further, having the fingers to undergo a long-term hitting motion may induce a specific type of injury. According to recent research, corresponding finger injury may be formed after continuous operation on the mobile phone or the tablet computer for 30 minutes. Clinically, it is found that acute tendinitis may occur to people who operate the mobile phones for hours.

Thanks to the increase in the realization accuracy of speech recognition systems, the future of introducing speech input to replace traditional hand input with new kinds of input devices can be foreseen. Then, fatigue on the fingers as well as the hands would be relieved without sacrificing input speed.

Currently, two input methods are available in the field of speech input technology: direct talk over the microphone of the 3C product such as the mobile phone, and speech input through cable or wireless microphone. No matter which kind of input method used, outdoor application is always a problem. In the outdoor environment, receiving quality of the microphone would be limited by the surrounding noises, thus recognition accuracy of the software would be affected. To some extent, the speech recognition system finds it hard to tell if the receiving sound is from the user, people nearby or simply background noise. Empirically, the interference voices may come from a neighboring casual speech, chatter, public broadcasting in a mall, or any noise/voice source, which may confuse the recognition system. On the other hand, if the user speaks in a comparatively quiet place, then the personal privacy would become another problem, though the speech recognition system might be best operated under such a condition.

Hence, in order to overcome the aforesaid shortcomings in applying the speech recognition system, an improvement thereupon to the 3C smart products is worthwhile and definitely welcome.

### SUMMARY OF THE INVENTION

Accordingly, it is the primary objective of the present invention to provide a 3C smart ring, which can be integrated with the user's portable 3C electronic products in a cable or wireless coupling manner. Through the 3C smart ring, user's speech can be transmitted to the 3C products, and can also be transformed into corresponding wording through a built-in speech recognition system for further forwarding to a third party via a relevant communicative software. The 3C smart ring is aimed at replacing the current screen keyboard and is to enhance the input efficiency. By providing the 3C smart ring and the built-in speech recognition system, the user's speech as well as the voice control command can be wireless and accurately sent to the 3C products at an extended distance that cannot be achieved by most of the current devices.

It is another objective of the present invention to provide a 3C smart ring that can cable or wirelessly transmit the speech and can transform the speech into corresponding wording, such that the conventional keyboard input can be replaced. Also, finger activity of the user can be substantially reduced and thus the possibility of acute tendinitis can be significantly reduced so that the user health can be improved.

It is a further object of the present invention to provide a 3C smart ring that can be worn on the finger and the relevant input performed simply by speaking to the ring. Also, a hand position to protect the ring from foreign noise interference can also benefit the receiving quality of the ring, and thus the performance of the recognition software can be ensured. Further, thereby, the volume of the user speech can be low so that the personal privacy can be guaranteed.

One more objective of the present invention is to provide a 3C smart ring that can further include a voice signal plughole for receiving user's earphone. As soon as the earphone engages in the voice signal plughole, the signals of the 3C products can be directly transmitted or received via a transmitting/receiving unit of the 3C smart ring. Namely, the 3C smart ring with an engaged earphone can thus perform like a Bluetooth device. Also, through a micro USB socket of the 3C smart ring, data in a USB drive, a micro USB, or a micro USB with an OTG wire can be accessed via the transmitting/receiving unit of the 3C smart ring, and thus the 3C smart ring of the present invention can perform as a midway station for data transmission.

One more further objective of the present invention is to provide a 3C smart ring that can further include a tri-axial gyroscope chip for detecting hand motions of the user so as further to obtain remote control upon various preset functions of the 3C products coupling the 3C smart ring.

To achieve the aforesaid objectives of the present invention, the 3C smart ring mainly includes a ring body, a power supply unit, a power switch, a control unit, a transmitting/receiving unit and a microphone. The power supply unit, the control unit and the transmitting/receiving unit are all located inside the ring body. The power supply unit and the transmitting/receiving unit are both coupled electrically with the control unit. The power supply unit is to provide electricity for operating the 3C smart ring. Through the transmitting/receiving unit, the 3C smart ring of the present invention can couple via wireless signals to a smart phone, a tablet computer, or any 3C product the like. Further, the power switch and the microphone are located at a lateral side of the ring body, in which the power switch for controlling on/off of the whole ring is coupled electrically with the control unit. The microphone coupled electrically with the control unit is to forward the received voice signals to the networking 3C products such as smart phones and tablet computers via the control unit and the transmitting/receiving unit.

All these objectives are achieved by the 3C smart ring described below.

### BRIEF DESCRIPTION OF THE DRAWINGS

The present invention will now be specified with reference to its preferred embodiment illustrated in the drawings, in which:

FIG. 1 is a schematic perspective view of an embodiment of the 3C smart ring in accordance with the present invention;

FIG. 2 demonstrates perspective that the 3C smart ring of FIG. 1 is worn on a user's finger;

FIG. 3 shows another state of FIG. 2;

FIG. 4 is a block diagram of the circuitry used in the 3C smart ring in accordance with the present invention; and

FIG. 5 demonstrates a gesture of the user hand wearing the 3C smart ring in accordance with the present invention.

### DESCRIPTION OF THE PREFERRED EMBODIMENT

The invention disclosed herein is directed to a 3C smart ring. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

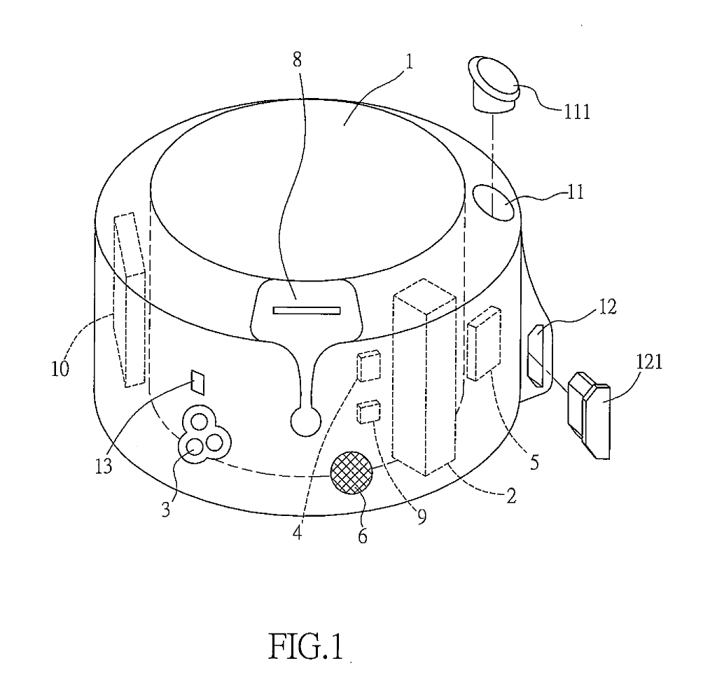

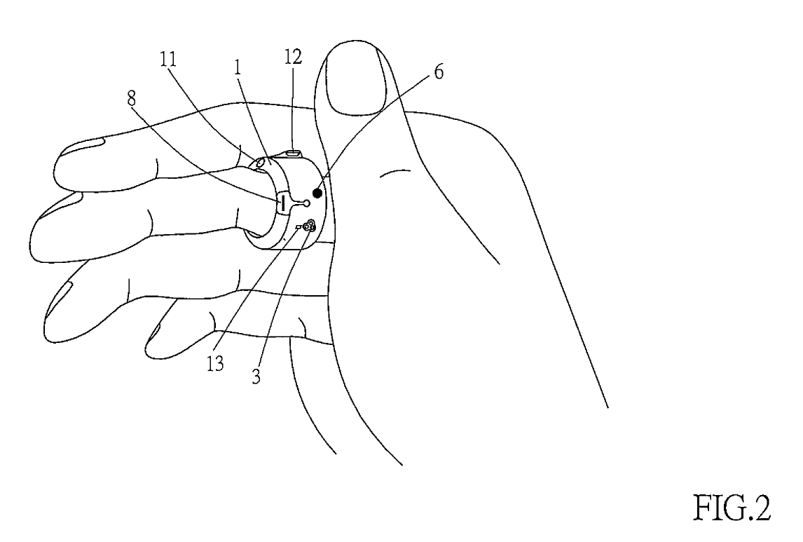

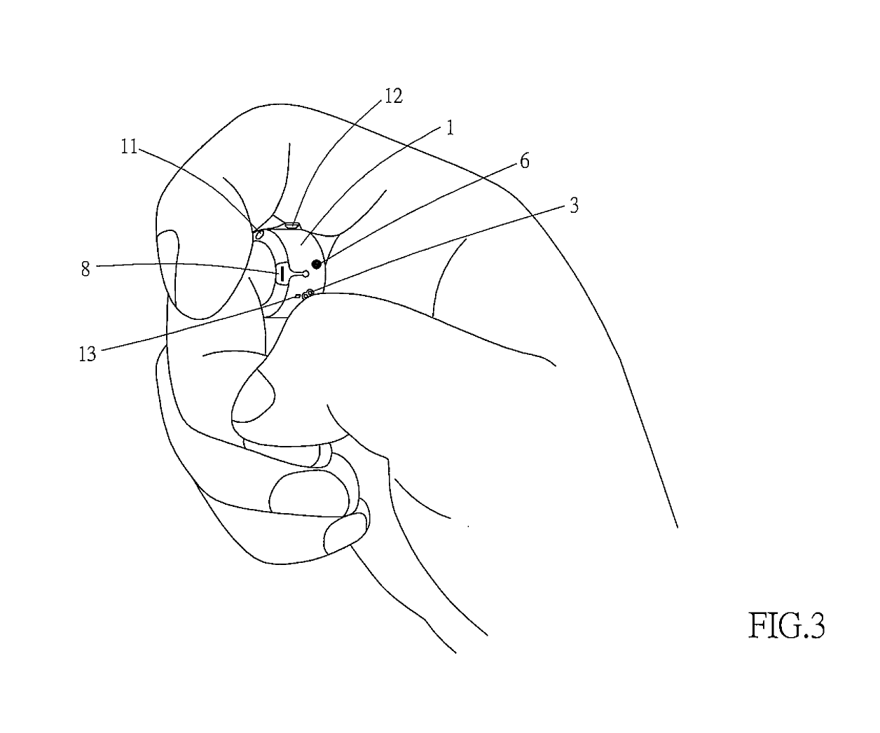

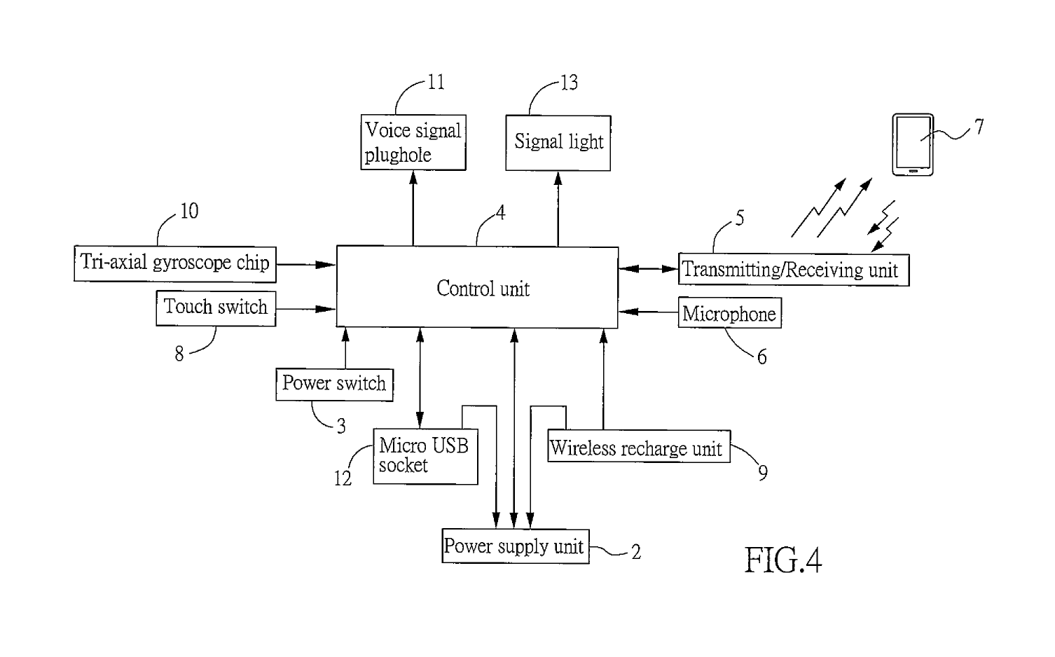

Refer now to FIG. 1 through FIG. 4, in which FIG. 1 is a schematic perspective view of an embodiment of the 3C smart ring in accordance with the present invention, FIG. 2 demonstrates perspective that the 3C smart ring of FIG. 1 is worn on a user's finger, FIG. 3 shows another state of FIG. 2, and FIG. 4 is a block diagram of the circuitry used in the 3C smart ring in accordance with the present invention. The 3C smart ring of the present invention is capable of coupling or connecting with a smart phone 7, a tablet, a computer or any built-in operation system for 3C products in a cable or wireless connection manner. The 3C smart ring mainly includes a ring body 1, a power supply unit 2, a power switch 3, a control unit 4, a transmitting/receiving unit 5 and a microphone 6. The power supply unit 2, the control unit 4 and the transmitting/receiving unit 5 are all located inside the ring body 1. The power supply unit 2 and the transmitting/receiving unit 5 are both coupled electrically with the control unit 4. The power supply unit 2 is to provide power or electricity to the 3C smart ring. Through the transmitting/receiving unit 5, the 3C smart ring can connect via wireless signal to a smart phone 7 (as shown in FIG. 4), a tablet, a computer or any built-in operation system for 3C apparatuses. The power switch 3 and the microphone 6 are both located to a lateral side of the ring body 1. The power switch 3 coupled electrically with the control unit 4 is to control the ON/OFF of the whole 3C smart ring. The microphone 6 is also coupled electrically with the control unit 4 is to forward the received foreign voice signals to the networking smart phone 7 (as shown in FIG. 4), tablet, computer or any built-in operation system for 3C apparatuses via the control unit 4 and the transmitting/receiving unit 5.

By providing the 3C smart ring of the present invention, the user needs only to turn on the power switch 3, and then the 3C smart ring can apply the transmitting/receiving unit 5 to establish signal connections with the smart phone 7, the tablet, the computer or any built-in operation system for the networking 3C apparatuses. In the case that a user wants to use his/her 3C products to input words via a software, a word-processing software for reports or an instant messaging software for replying friends' messages, he/she needs only to start the speech recognition software of his/her smart phone 7, then speaks his/her words to be input closely over the 3C smart ring worn on his/her finger of the fisted hand as shown in FIG. 3, further the microphone 6 would forward the voices of the words to the smart phone 7, the tablet, the computer or any built-in operation system for 3C apparatuses via the control unit 4 and the transmitting/receiving unit 5, and then the speech recognition system would transform the voices into corresponding words and to display the words via the communicative or word-processing software, or to perform remote voice control via a voice-control software.

By providing the 3C smart ring of the present invention, the user can utilize the transmitting/receiving unit 5 to easily and directly forward user's voice message to the networking smart phone 7, tablet, computer or any built-in operation system for 3C apparatuses. Further, by introducing the speech recognition system to transform the voice into corresponding words to be presented by the communicative or word-processing software. By comparing to the finger typing upon the conventional keyboard, the word input mechanism (through the 3C smart ring) for transforming the voice input in accordance with the present invention can provide a rapid input rate without sacrificing health of the fingers. Further, the ring form of the 3C smart ring in accordance with the present invention makes possible the miniaturization of the product and also operational efficiency. Also, compared to the conventional ear-hang microphone, the input style of user's speech over a fisted hand with the 3C smart ring thereinside in accordance with the present invention can provide a clearer voice input without serious interference from environmental noises. Further, under the application of the 3C smart ring, privacy of the user can also be ensured. In addition, talking over personal fist is usually seen in daily life, and thus the application of the 3C smart ring would not cause embarrassment to the user and also would not attract people's attention. Thus, the application of the 3C smart ring is both convenient and comfortable to the user.

The present invention can serve as a regular Bluetooth transmitting/receiving module when connected to any 3C device, such as a smart phone 7, a tablet, a computer, or any such built-in operation system.

In the present invention, the microphone 6 is located at a side of the ring body 1 close to a user palm as shown in FIG. 2 and FIG. 3. With the user having his/her hand fisted, the microphone 6 would shift closer to the center of the fisted hand and thus to a position that is easy to receive the user's voice.

In the present invention, the ring body 1 further includes a touch switch 8 located at a front side thereof close to the user finger and coupled electrically with the control unit 4. In particular, the touch switch 8 is located at a touchable position while bending the user finger. Function of the touch switch 8 is similar to the “send” key of the wireless phone. Only when the user makes his/her hand in a fist state and has a front end of the folded finger to press the touch switch 8, then the received voice signals can be transmitted. Upon such an arrangement, the 3C smart ring does not need to stand by all the time, and also only the selective voice or speech can be transmitted to the networking 3C products. Thus, the 3C smart ring can save energy, extend its standby time, and receive only the user speech by the microphone 6 (not neighbor's speech or careless broadcast).

In the present invention, the ring body 1 further includes a voice signal plughole 11 and/or a micro USB socket 12. The voice signal plughole 11 and the micro USB socket 12 are both coupled electrically with the control unit 4. Along with the voice signal plughole 11 and the micro USB socket 12, the 3C smart ring of the present invention can then perform as a relay device or a midway device for signal transmission. For example, upon applying a cable earphone to the voice signal plughole 11, the transmitting/receiving unit 5 of the 3C smart ring can then receive and play music transmitted by the 3C products hence performing as a Bluetooth device. Further, by providing the micro USB socket 12, the user can recharge the power supply unit 2. It can also couple one device with a micro USB socket 12 with a second device without a micro USB socket 12 and operate together. For example, for a car dashcam with a micro USB socket but without a screen, in the event of an incident, the user may use the micro USB socket 12 to retrieve the image data of the dashcam through the 3C smart ring, and forward transmit the image data to the networking smart phone 7, tablet computer, or notebook computer that can provide instant replay via the transmitting/receiving unit 5 thereof. Further, via the micro USB socket 12, the user can accept a USB drive with a built-in micro USB or apply an OTG cable to connect a device without a micro USB, and then the transmitting/receiving unit 5 can be used to directly transmit or receive the data of a 3C device or a USB drive.

In the present invention, the voice signal plughole 11 and/or the micro USB socket 12 of the ring body 1 can be water and dust-proof formulated or can be furnished with a soft water and dust-proof plug 111 and/or 121, so that the advantages of waterproof and dustproof can be obtained while the voice signal plughole 11 and/or the micro USB socket 12 is free of any engagement.

In the present invention, the ring body 1 can further include at least a signal light 13 coupled electrically with the control unit 4. Through predetermined flashing or color change of the signal light 13, the user can easily be aware of various states of the 3C smart ring.

In the present invention, the ring body 1 can further include thereinside a wireless recharge unit 9 coupled electrically with the control unit 4. By providing the wireless recharge unit 9, the 3C smart ring can be recharged in a wireless manner.

In the present invention, both the wireless recharge unit 9 and the micro USB socket 12 can be coupled electrically with the power supply unit 2, such that the user can recharge the power supply unit 2 through either the wireless recharge unit 9 or the micro USB socket 12.

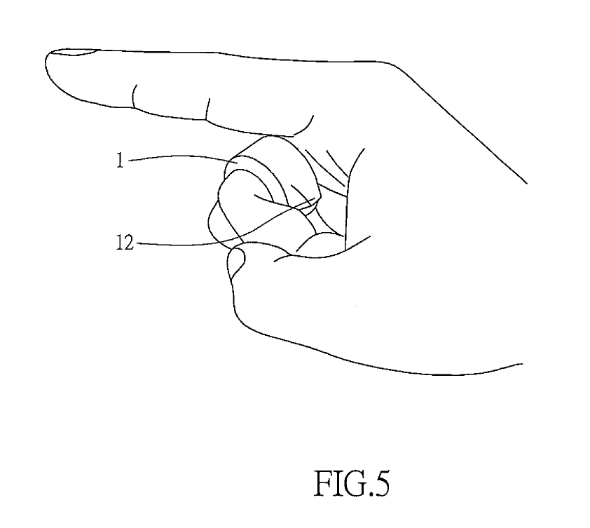

In the present invention, the ring body 1 can further include thereinside a tri-axial gyroscope chip 10 coupled electrically with the control unit 4. By providing the tri-axial gyroscope chip 10 and the touch switch 8, the user wearing the 3C smart ring can perform virtual writing with a finger configuration shown in FIG. 5 where the index finger is pointing while the other fingers are folded. Through the tri-axial gyroscope chip 10, the finger motion such as moving left, right, up, down or according to a regular or irregular shape, or a writing motion can be detected. Further, through the transmitting/receiving unit 5, the finger motion can be forwarded to the networking smart phone 7, tablet, computer, or any built-in operation system of the 3C device. By further introducing relevant APP software to realize the finger motion, the user can then control the 3C device coupled with the 3C smart ring by various finger motion associated with the 3C smart ring. In addition, the aforesaid virtual motion of the index finger highly resembles the corresponding practical finger motion, and also the touch switch 8 can be arbitrarily depressed by the user under the hand configuration of FIG. 5. Hence, upon such an arrangement, any virtual finger motion can be easily and accurately detected by the tri-axial gyroscope chip 10 only at the time when the touch switch 8 is depressed or properly triggered, and thus possible ill realization upon the virtual finger motion can be reduced to a minimum.

Furthermore, it shall be understood that the aforesaid embodiments are introduced to elucidate, but not to limit, the application of the 3C smart ring in accordance with the present invention. For the skill person in the art, it shall be understood that slight changes in the aforesaid embodiments such as the variations in formation or number of any foregoing element (the power switch 8 for example) would still be within the scope of the present invention.

By providing the 3C smart ring in accordance with the present invention, the user can comfortably and freely perform his/her private speech/voice input, and then the corresponding input can be accurately forwarded to the networking smart phone, tablet, computer or any other 3C device having a built-in operation system in a cable or wireless manner. Further, by integrating the built-in voice-control function of the 3C device or by applying the speech recognition system to transform the voice data into literal data so as to further present through user's word-processing software or communicative software, the input method associated with the 3C smart ring, which is obviously superior to the conventional typing method upon a solid or virtual keyboard, in both the input rate and the related finger load. Also, the ring formation of the present invention can minimize the volume of this 3C device without sacrificing user comfort, and can ensure both voice receiving quality and user privacy, compared to the traditional ear-hung microphone.

While the present invention has been particularly shown and described with reference to a preferred embodiment, it will be understood by those skilled in the art that various changes in form and detail may be possible without departing from the spirit and scope of the present invention.

What is claimed is:

1. A 3C smart ring, capable of coupling with a 3C product such as a smart phone, a tablet, a computer and any built-in operation system the like in a cable or wireless communication manner, comprising:
a ring body for being applied to a user finger;
a power supply unit, located inside the ring body to provide electricity;
a power switch, located at a side of the ring body to control on/off of the power supply unit, electrically coupled with a control unit;
the control unit, locate inside the ring body, electrically coupled with the power supply unit;
a transmitting/receiving unit, located inside the ring body, electrically coupled with the control unit so as to transmit/receive signals under a control of the control unit; and
a microphone, located inside the ring body, electrically coupled with the control unit, transmitting foreign voice signals to the control unit and forwarding signals to a coupling 3C product via the transmitting/receiving unit.

2. The 3C smart ring of claim 1, wherein the transmitting/receiving unit is a Bluetooth module.

3. The 3C smart ring of claim 1, wherein the ring body further includes a voice signal plughole coupled electrically with the control unit.

4. The 3C smart ring of claim 3, wherein the voice signal plughole further be furnished with a water and dust-proof plug.

5. The 3C smart ring of claim 1, wherein the ring body further includes a micro USB socket coupled electrically with the control unit.

6. The 3C smart ring of claim 5, wherein the micro USB socket is further coupled electrically with the power supply unit.

7. The 3C smart ring of claim 5, wherein the micro USB socket is further furnished with a water and dust-proof plug.

8. The 3C smart ring of claim 1, wherein the ring body further includes a signal light coupled electrically with the control unit.

9. The 3C smart ring of claim 1, wherein the ring body further includes thereinside a wireless recharge unit coupled electrically with the control unit.

10. The 3C smart ring of claim 9, wherein the wireless recharge unit is coupled electrically with the power supply unit.

11. The 3C smart ring of claim 1, wherein the ring body further includes a touch switch located at a front side thereof close to the user finger and coupled electrically with the control unit.

12. The 3C smart ring of claim 11, wherein the touch switch is located at a touchable position while bending the user finger.

13. The 3C smart ring of claim 1, wherein the microphone is located at a side of the ring body close to a user palm.

14. The 3C smart ring of claim 1, wherein the ring body further includes a tri-axial gyroscope chip coupled electrically with the control unit.
